(19) United States
(12) Patent Application Publication
(10) Pub. No.: US 2013/0164076 A1
(43) Pub. Date: Jun. 27, 2013

(54) PIVOT PIN SECURING STRUCTURE

(71) Applicant: FIRST DOME CORPORATION, Taipei County (TW)

(72) Inventors: AN SZU HSU, TAIPEI COUNTY (TW); CHIEN-NAN TSAI, TAIPEI COUNTY (TW)

(73) Assignee: FIRST DOME CORPORATION, TAIPEI COUNTY (TW)

(21) Appl. No.: 13/684,837

(22) Filed: Nov. 26, 2012

Related U.S. Application Data
(62) Division of application No. 13/108,022, filed on May 16, 2011.

(51) Int. Cl. F16C 11/04

(52) U.S. Cl. CPC F16C 11/04
USPC 403/119

(57) ABSTRACT

A pivot pin securing structure includes a support seat and a pivot pin. The support seat is formed with a bush section with a pinhole. The bush section is formed with a split in communication with the pinhole, whereby the bush section has elasticity for holding the pivot pin. The bush section has at least one independent spring section. An obliquely extending track section is disposed on at least one side of the spring section. One end of the pivot pin extends into the pinhole. An abutment member is disposed on a circumference of the pivot pin. The abutment section is slidable along the track section with the rotation of the pivot pin in abutment with the spring section to different extents. During the sliding movement, the spring section applies different reaction forces to the abutment section as resistance against and aid force for the rotation of the pivot pin.

REFERENCE TO RELATED APPLICATIONS

This Application is being filed as a Divisional Application of U.S. Ser. No. 13/108,022, filed 16 May 2011, currently pending.

### BACKGROUND OF THE INVENTION

1. Field of the Invention

The present invention relates generally to a pivot pin securing structure, and more particularly to a pivot pin structure, which is simplified and easy to assemble and install. The pivot pin structure can be securely assembled without swinging.

2. Description of the Related Art

FIGS. 1 and 2 show a conventional pivot pin structure with rotational fastening and locating function. The pivot pin structure includes a support seat 4, a pivot pin 5 and a restriction assembly 6. The support seat 4 can be mounted on a main body of an electronic device (such as a notebook). One end section of the support seat 4 is bent to form a support section 43. The support section 43 has a circular pinhole 41. Located sections 42 (such as dents) are disposed beside the pinhole 41. A plane cut face is formed on the circumference of the pivot pin 5. One end of the pivot pin 5 is formed with an outer thread 51. The other end of the pivot pin 5 is connectable with a connection section 53 via a stop section 52. The connection section 53 is connectable with a pivotable component (such as a screen) of the electronic device. After the pivot pin 5 is fitted through the pinhole 41, an elastic member 56 (spring) is fitted on the pivot pin 5. Then an anti-slip washer 54 with greater frictional performance is synchronously rotatably fitted on the pivot pin 5. Finally, a nut 55 is screwed on the outer thread 51 to securely connect the pivot pin 5 with the support seat 4. The restriction assembly 6 is composed of a first fastening member 61 and a second fastening member 62, which can be fitted on the pivot pin 5. Locating sections 621, (which can be bosses), are disposed on one side of the second fastening member 62. The locating sections 621 can be connected with the located sections 42 (dents) of the support section 43 and located therein. Two opposite slopes 622, 623 are disposed on the other side of the second fastening member 62 proximal to one side of the first fastening member 61. The first fastening member 61 is synchronously rotatable with the pivot pin 5. Two opposite protruding stop sections 611 are formed on one side of the first fastening member 61 proximal to the second fastening member 62. The stop sections 611 serve to abut against the slopes 622, 623. By means of the elastic force of the elastic member 56, the first and second fastening members 61, 62 are kept securely connected without loosening. In operation, the first fastening member 61 is synchronously rotated with the pivot pin 5. Accordingly, the stop sections 611 can slide along the slopes 622, 623 forward and backward to provide a gradually fastening or push aid effect for the pivot pin 5 during the rotation.

In the above structure, the pivot pin 5 simply contacts with the inner circumference of the pinhole 41 of the support seat 4 with the stop section 52 abutting against one side of the support section 43. Therefore, the contact area between the pivot pin 5 and the support seat 4 is quite small so that the pivot pin 5 can be hardly securely connected with the support seat 4. The elastic member 56 is relied on to provide strong elastic force for pushing the restriction assembly 6 against the support section 43. Accordingly, the restriction assembly 6 and the stop section 52 cooperate to clamp the support section 43 to prevent the pivot pin 5 from swinging during the rotation of the pivot pin 5. The stability of the connect ion between the pivot pin 5 and the support seat 4 is indirect proportion to the elasticity of the elastic member 56. However, excessively large elastic force leads to increase of the applied force in operation. This makes it inconvenient to operate the pivot pin structure and results in serious wear of the components, especially the restriction assembly 6. Therefore, it often takes place that the pivot pin 5 loosens and the components damage and fail. Under such circumstance, it is often necessary to retighten the nut 55 to ensure the pivot pin 5 is securely connected with the support seat 4. Furthermore, the pivot pin structure includes too many components and has a complicated configuration. As a result, it is hard to assemble the components. This leads to increase of manufacturing cost and lower competitive ability of the product.

### SUMMARY OF THE INVENTION

It is therefore a primary object of the present invention to provide a pivot pin securing structure, The pivot pin is fitted in the bush section of the support seat and enclosed in the bush section by a large contact area. Therefore, the pivot pin is securely connected with the bush section without swinging or loosening during rotation of the pivot pin.

It is a further object of the present invention to provide the above pivot pin securing structure. When the pivot pin is rotated, the pivot pin securing structure is able to exert a resistance against the rotation of the pivot pin or an aid force for the rotation of the pivot pin. Also, during the rotation of the pivot pin, the pivot pin can be located in any predetermined angular position.

It is still a further object of the present invention to provide the above pivot pin securing structure, which is simplified and easy to assemble and install. Therefore, the manufacturing cost is lowered to promote competitive ability of the product.

To achieve the above and other objects, the pivot pin securing structure of the present invention includes: a support seat formed with a pinhole, at least one independently extending spring section being disposed on a circumference of the pinhole; and a pivot pin at least partially extending into the pinhole of the support seat, an abutment member being disposed on a circumference of the pivot pin corresponding to the spring section, the abutment section serving to slide along the track section with the forward and backward rotation of the pivot pin in abutment with the spring section to different extents, whereby the spring section applies different reaction forces to the abutment section as resistance against and aid force for the sliding movement.

In the above pivot pin securing structure, an at least partially oblique track section is disposed on at least one side of the spring section in contact with the abutment section. The abutment member is a protrusion slidable along the track section.

In the above pivot pin securing structure, the support seat has a bush section defining the pinhole. The bush section is formed with a split in communication with the pinhole, whereby the bush section has elasticity for holding the pivot pin.

In the above pivot pin securing structure, the pivot pin has an end section positioned outside the pinhole. The end section is partially circumferentially formed with a bulged stop section. The bush section is formed with a guide notch corresponding to the stop section for receiving the stop section.

In the above pivot pin securing structure, the pivot pin has an end section positioned outside the pinhole. A connection section is disposed at the end section of the pivot pin. The connection section is connectable with a corresponding connected section of a connection member, whereby the pivot pin can be assembled and connected with the connection member.

The present invention can be best understood through the following description and accompanying drawings, wherein:

### BRIEF DESCRIPTION OF THE DRAWINGS

FIG. 1 is a perspective exploded view of a conventional pivot pin structure with limited rotational angle;

FIG. 2 is a perspective assembled view of the conventional pivot pin structure according to FIG. 1;

FIG. 3 is a perspective exploded view of a first embodiment of the present invention;

FIG. 4 is a perspective assembled view of the first embodiment of the present invention;

FIG. 5 is a perspective assembled view of the first embodiment of the present invention in a closed state;

FIG. 6 is a plane view of the first embodiment of the present invention in a closed state;

FIG. 7 is a perspective assembled view of the first embodiment of the present invention in an opened state;

FIG. 8 is a plane view of the first embodiment of the present invention in an opened state;

FIG. 9 is a perspective exploded view of a second embodiment of the present invention;

FIG. 10 is a perspective exploded view of a third embodiment of the present invention;

FIG. 11 is a perspective exploded view of a fourth embodiment of the present invention;

FIG. 12 is a perspective exploded view of a fifth embodiment of the present invention; and

FIG. 13 is a perspective exploded view of a sixth embodiment of the present invention.

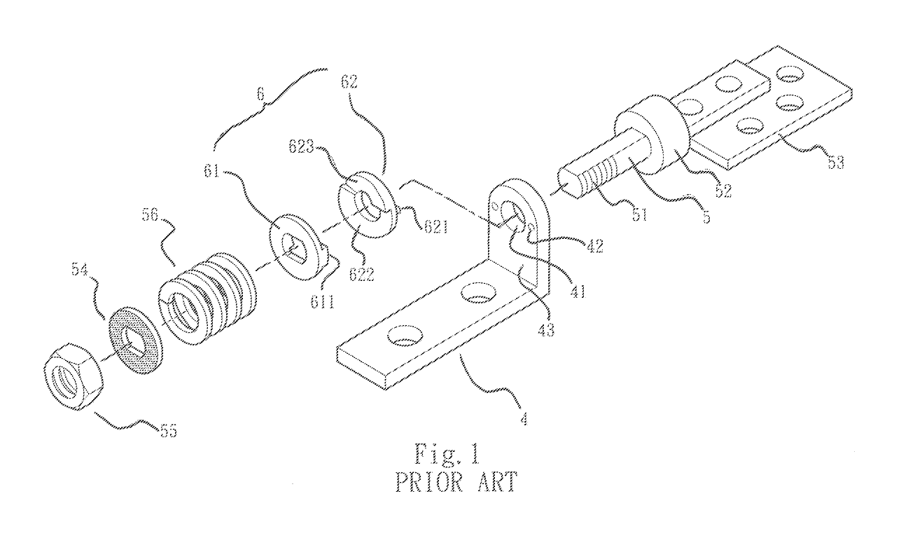

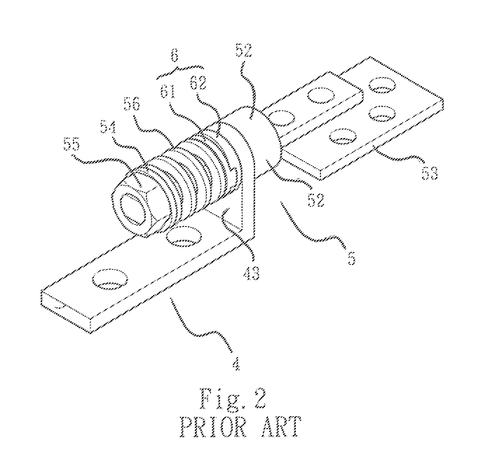

### DETAILED DESCRIPTION OF THE PREFERRED EMBODIMENTS

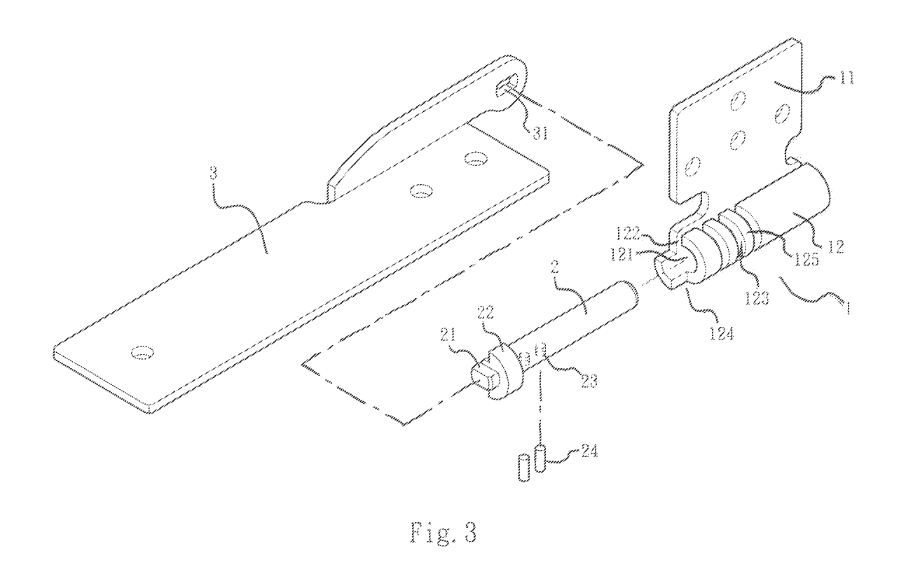

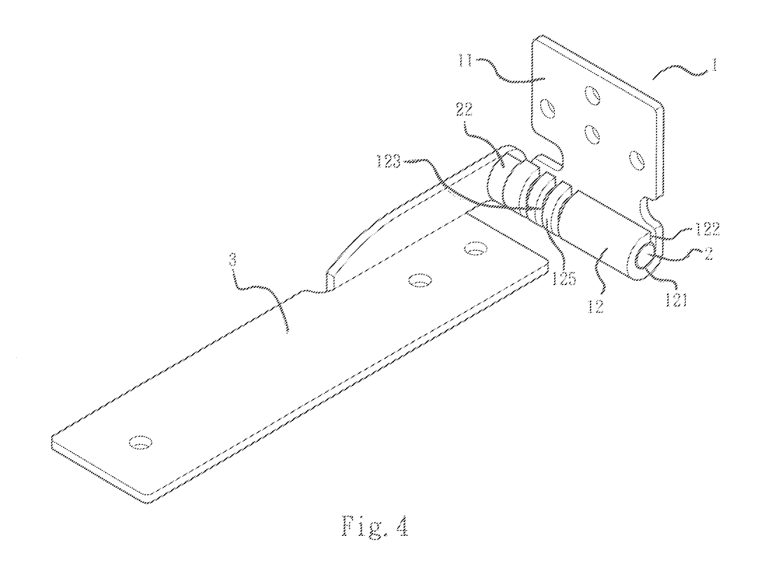

Please refer to FIGS. 3 and 4. The present invention includes a support seat 1 and a pivot pin 2. The support seat 1 is formed with a fixing section 11 fixable to a main body of an electronic device (such as a notebook). The support seat 1 is further formed with a bush section 12 on one side. The bush section 12 has a pinhole 121 in communication with the exterior side through a split 122, whereby the bush section 12 has elasticity for holding the pivot pin 2. The bush section 12 has multiple independent spring sections 125 defining multiple oblique or arcuate track sections 123 (which can be split tracks) therebetween. The track sections 123 can be tracks in communication with the split 122. One end of the bush section 12 is partially circumferentially formed with a guide notch 124. One end of the pivot pin 2 extends into the pinhole 121 of the support seat 1. Multiple locating sections 23are formed on a circumference of the pivot pin 2 corresponding to the track sections 123 (track splits) of the bush section 12 respectively. The locating sections 23 can be dents in which abutment members 24 (which can be insertion pins) can be inserted respectively. The abutment members 24 serve as protrusions movable along the track sections 123 in abutment with the spring sections 125. The pivot pin 2 has an outer end section positioned outside the pinhole 121. The outer end section is partially circumferentially formed with a bulged stop section 22 extending into the guide notch 124. Two end sections of the guide notch 124 serve to stop the stop section 22 to restrict rotational angle of the pivot pin 2. In addition, a connection section 21 (which can be a protrusion) is disposed at the outer end section of the pivot pin 2. The connection section 21 can be assembled with a corresponding connected section 31 of a connection member 3. The connected section 31 can be a perforation in which the connection section 21 can be inserted. Accordingly, the pivot pin 2 can be assembled and connected with the connection member 3. The connection member 3 is connectable with a movable section (such as a screen) of the electronic device (notebook).

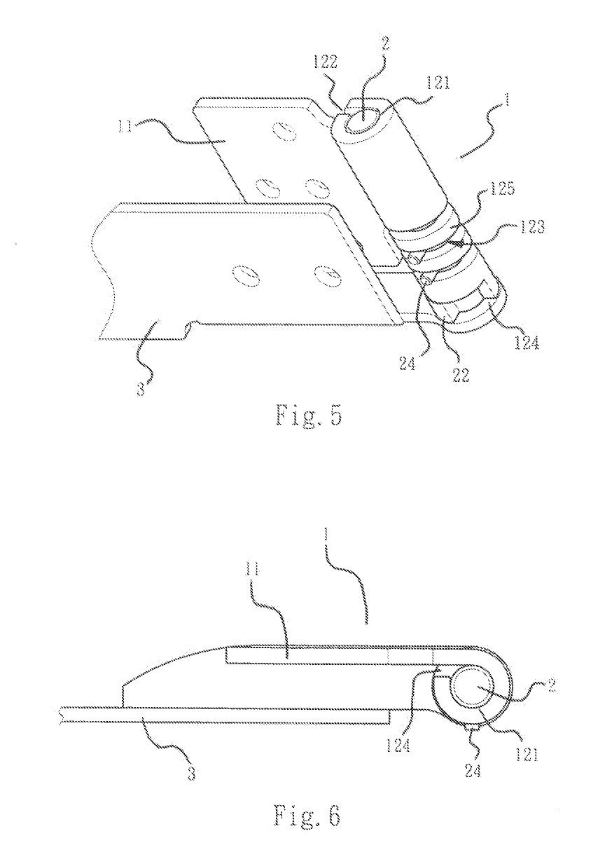

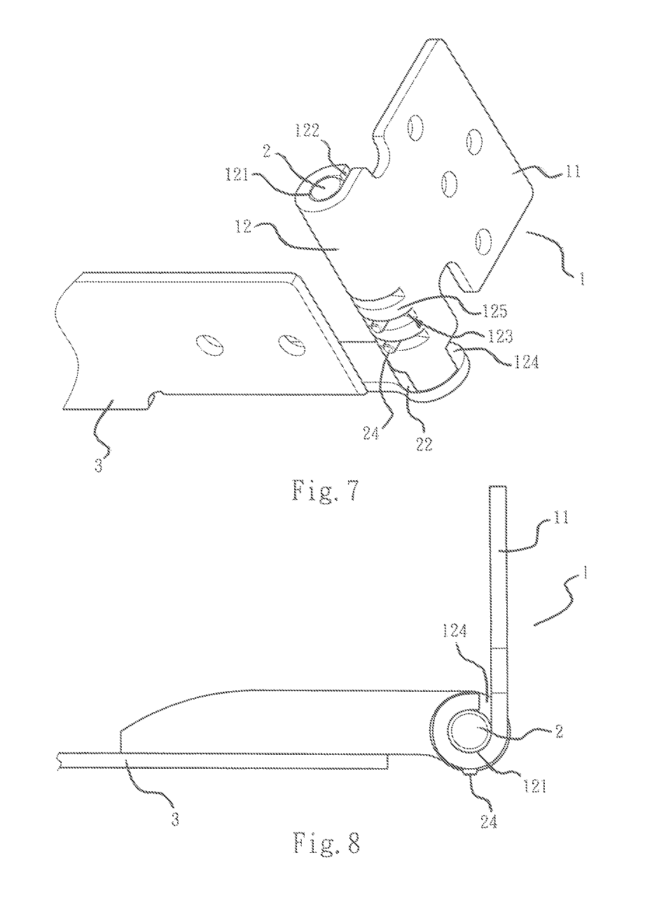

Please refer to FIGS. 5 to 8. In operation, when the pivot pin 2 and the support seat 1 are in a fully closed state (as shown in FIGS. 5 and 6), the abutment members 24 (protrusions) abut against the track sections 123 to a maximum extent. At this time, the spring sections 125 are deformed by a maximum deformation. Responsively, the spring sections 125 apply a maximum reaction force to the abutment members 24. Accordingly, when gradually opened, the abutment members 24 slide along the track sections 123 with the rotation of the pivot pin 2. During the sliding movement, the reaction force of the spring sections 125 serves as a push aid force for the abutment members 24. Therefore, under the push aid force, only less push force is needed for opening the pivot pin 2. When the pivot pin 2 and the support seat 1 are in a fully opened state (as shown in FIGS. 7 and 8), the abutment members 24 (protrusions) abut against the spring sections 125 to a minimum extent. At this time, the abutment members 24 contact with the spring sections 125 at a start point and the spring sections 125 apply a minimum reaction force to the abutment members 24. Accordingly, when gradually closed, the abutment members 24 slide along the track sections 123 with the rotation of the pivot pin 2 to gradually push and deform the spring sections 125. At the same time, the reaction force applied by the spring sections 125 to the abutment members 24 gradually increases as a resistance against rotation of the pivot pin 2. Therefore, it is relatively uneasy to close the connection member 3 and the connection member 3 can be located in any angular opened position.

Reversely, the track sections 123 of the spring sections 125 can be designed with oblique or arcuate configuration directed in a reverse direction in accordance with the requirement of different application field. In this case, a reverse effect is achieved. That is, when opened, a greater resistance against the rotation is applied to the pivot pin 2, while when closed, a smaller resistance against the rotation is applied to the pivot pin 2. The track sections 123 can be designed as simply obliquely extending tracks. Alternatively, the track sections 123 can be designed with an arcuate configuration or a configuration with at least one waved section. In this case, during the rotation, the pivot pin 2 can be locally located in an angular position.

The pivot pin 2 is fitted in the pinhole 121 of the bush section 12 and enclosed in the bush section 12 by a large contact area. Therefore, the pivot pin 2 is securely connected with the bush section 12 without swinging during rotation of the pivot pin 2. Furthermore, the number of the components of the present invention is smaller and the structure of the present invention is simplified and is easy to assemble and install. Therefore, the manufacturing cost is lowered to promote competitive ability of the product.

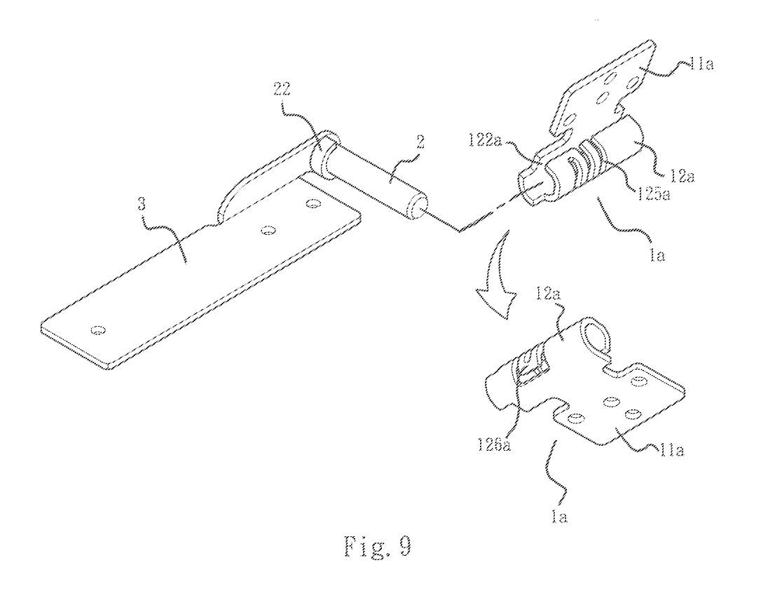

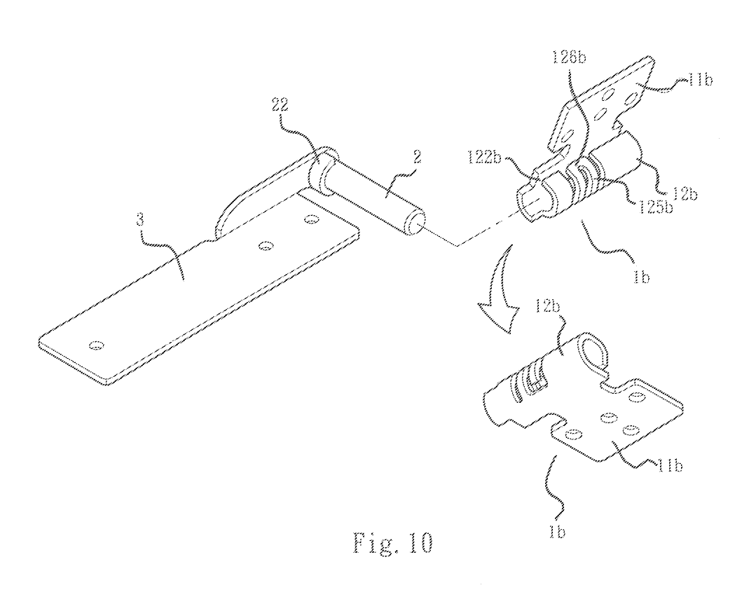

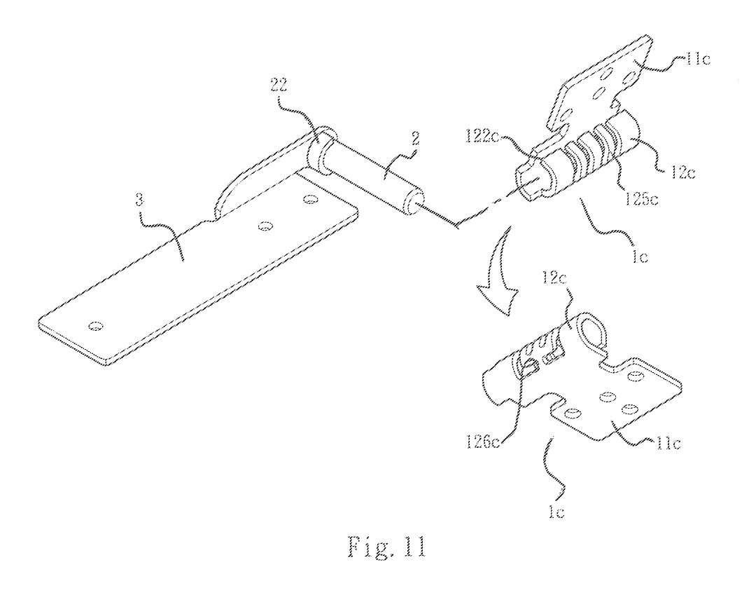

Please refer to FIG. 9, which shows a second embodiment of the present invention. In this embodiment, the support seat la has a different structure. A split 122a is formed between one side of the bush section 12a and the fixing section 11a. The bush section 12a has multiple spring sections 125a. The head and tail ends of the spring sections 125a are connected via an interconnection section 126a. One end of one of the spring sections 125a is connected with the bush section 12a on one side proximal to the split 122a. The other parts of the support seat la are identical to those of the support seat 1 of the first embodiment. Please refer to FIG. 10, which shows a third embodiment of the present invention. In this embodiment, the support seat lb has a different structure. A split 122b is formed between one side of the bush section 12b and the fixing section 11b. The bush section 12b has multiple spring sections 125b. The head and tail ends of the spring sections 125b are connected via an interconnection section 126b. One end of one of the spring sections 125b is connected with the bush section 12b on one side distal from the split 122b. The other parts of the support seat 1b are identical to those of the support seat 1 of the first embodiment.

Please refer to FIG. 11, which shows a fourth embodiment of the present invention. In this embodiment, the support seat 1c has a different structure. A split 122c is formed between one side of the bush section 12c and the fixing section 11c. The bush section 12c has multiple spring sections 125c. Each spring section 125c has a fixed end and a free end. The fixed ends of the spring sections 125c are connected with each other on one side distal from the split 122c and connected with the bush section 12c via an interconnection section 126c. The multiple spring sections 125c extend from the interconnection section 126c of the bush section 12c toward the split 122c in the form of a fork. The other parts of the support seat 1c are identical to those of the support seat 1 of the first embodiment.

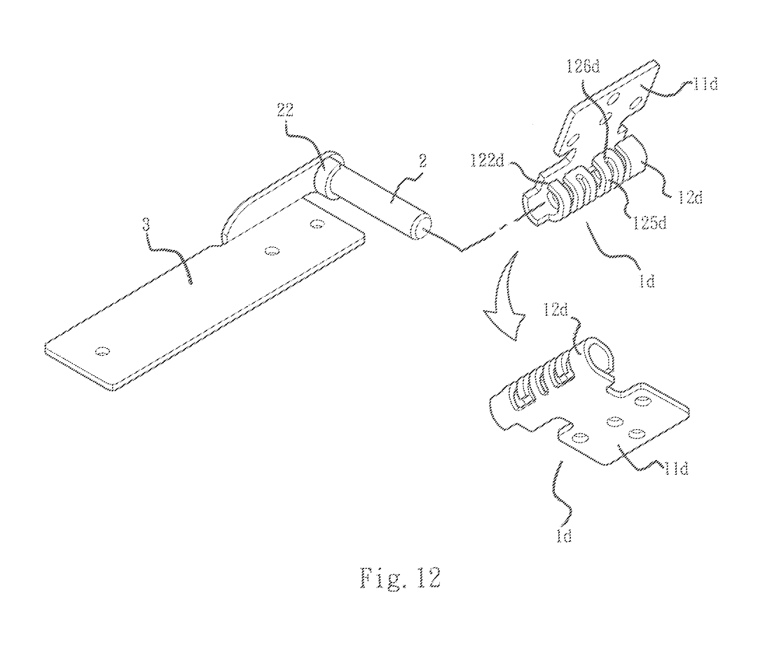

Please refer to FIG. 12, which shows a fifth embodiment of the present invention. In this embodiment, the support seat 1d has a different structure. A split 122d is formed between one side of the bush section 12d and the fixing section 11d. The bush section 12d has multiple spring sections 125d. The head and tail ends of the lateral spring sections 125d and the middle spring sections 125d are symmetrically connected via an interconnection section 126d. The middle spring sections 125d are further connected with the bush section 12d on one side distal from the split 122d. The other parts of the support seat 1d are identical to those of the support seat 1 of the first embodiment.

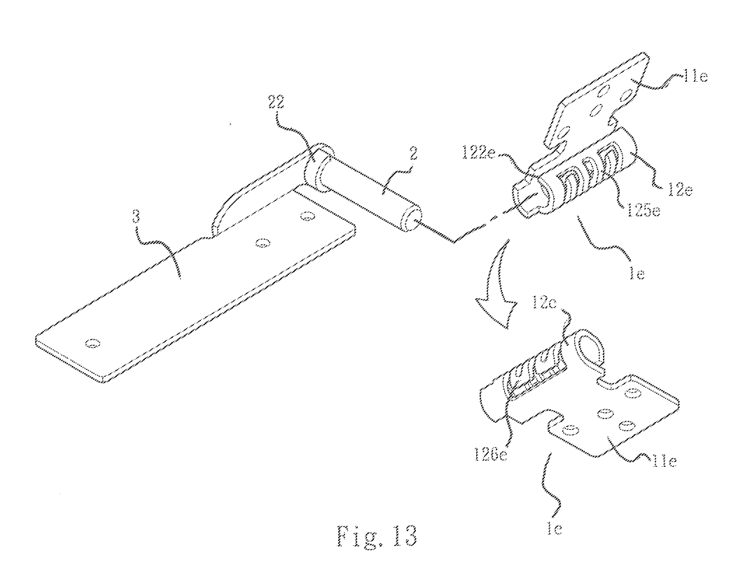

Please refer to FIG. 13, which shows a sixth embodiment of the present invention. In this embodiment, the support seat le has a different structure. A split 122e is formed between one side of the bush section 12e and the fixing section 11e. The bush section 12e has multiple spring sections 125e. The head and tail ends of the spring sections 125e are connected via an interconnection section 126e. The spring sections 125e are further connected with the bush section 12e on one side proximal to the split 122e. The other parts of the support seat le are identical to those of the support seat 1 of the first embodiment.

According to the above arrangement, the pivot pin securing structure of the present invention is simplified and easy to assemble and install. The pivot pin can be securely connected with the bush section without swinging.

The above embodiments are only used to illustrate the present invention, not intended to limit the scope thereof. Many modifications of the above embodiments can be made without departing from the spirit of the present invention.

What is claimed is:

1. A pivot pin securing structure comprising:
a support seat formed with a pinhole, at least one independently extending spring section being disposed on a circumference of the pinhole, an at least partially oblique track section being disposed on the spring section; and
a pivot pin at least partially extending into the pinhole of the support seat, an abutment member being disposed on a circumference of the pivot pin corresponding to the spring section, the abutment section serving to slide along the track section with the forward and backward rotation of the pivot pin in abutment with the spring section to different extents, whereby the spring section applies different reaction forces to the abutment section as resistance against and aid force for the sliding movement; and the support seat has a bush section defining the pinhole, the bush section being formed with a split in communication with the pinhole, whereby the bush section has elasticity for holding the pivot pin; and the bush section has multiple spring sections, head and tail ends of lateral spring sections and the middle spring sections are symmetrically connected, the middle spring sections being connected with the bush section on one side proximal to the split.

2. The pivot pin securing structure as claimed in claim 1, wherein the track section extends in an oblique path.

3. The pivot pin securing structure as claimed in claim 1, wherein the track section extends in an arcuate path.

4. The pivot pin securing structure as claimed in claim 1, wherein the track section extends in a waved path.
